(19) United States
(12) Patent Application Publication
(10) Pub. No.: US 2025/0046069 A1
(43) Pub. Date: Feb. 6, 2025

(54) LABEL-FREE VIRTUAL IMMUNOHISTOCHEMICAL STAINING OF TISSUE USING DEEP LEARNING

(71) Applicant: THE REGENTS OF THE UNIVERSITY OF CALIFORNIA, Oakland, CA (US)

(72) Inventors: Aydogan Ozcan, Los Angeles, CA (US); Yair Rivenson, Los Angeles, CA (US); Bijie Bai, Los Angeles, CA (US); Hongda Wang, Los Angeles, CA (US)

(73) Assignee: THE REGENTS OF THE UNIVERSITY OF CALIFORNIA, Oakland, CA (US)

(21) Appl. No.: 18/715,333

(22) PCT Filed: Nov. 30, 2022
(86) PCT No.: PCT/US2022/080697

§ 371 Date: May 31, 2024

Related U.S. Application Data
(60) Provisional application No. 63/287,006, filed on Dec. 7, 2021.

(51) Int. Cl. G06V 10/82; G06V 10/143; G06V 20/69

(52) U.S. Cl. CPC G06V 10/82; G06V 10/143; G06V 20/693; G06V 20/698; G06V 2201/03

(57) ABSTRACT

A deep learning-based virtual HER2 IHC staining method uses a conditional generative adversarial network that is trained to rapidly transform autofluorescence microscopic images of unlabeled/label-free breast tissue sections into bright-field equivalent microscopic images, matching the standard HER2 IHC staining that is chemically performed on the same tissue sections. The efficacy of this staining framework was demonstrated by quantitative analysis of blindly graded HER2 scores of virtually stained and immunohistochemically stained HER2 whole slide images (WSIs). A second quantitative blinded study revealed that the virtually stained HER2 images exhibit a comparable staining quality in the level of nuclear detail, membrane clearness, and absence of staining artifacts with respect to their immunohistochemically stained counterparts. This virtual staining framework bypasses the costly, laborious, and time-consuming IHC staining procedures in laboratory, and can be extended to other types of biomarkers to accelerate the IHC tissue staining and biomedical workflow.

### RELATED APPLICATION

This Application claims priority to U.S. Provisional Patent Application No. 63/287,006 filed on Dec. 7, 2021, which is hereby incorporated by reference in its entirety. Priority is claimed pursuant to 35 U.S.C. § 119 and any other applicable statute.

### STATEMENT REGARDING FEDERALLY SPONSORED Research and Development

This invention was made with government support under Grant Number 1926371, awarded by the National Science Foundation. The government has certain rights in the invention.

### TECHNICAL FIELD

The technical field generally relates to methods and systems used to image unstained (i.e., label-free) tissue including, in one embodiment, breast tissue. In particular, the technical field relates to microscopy methods and systems that utilize deep neural network learning for digitally or virtually staining of images of unstained or unlabeled tissue that substantially resemble immunohistochemical (IHC) staining of the tissue. In one example, this includes breast tissue and IHC staining of the human epidermal growth factor receptor 2 (HER2) biomarker.

### Background

The immunohistochemical (IHC) staining of tissue sections plays a pivotal role in the evaluation process of a broad range of diseases. Since its first implementation in 1941, a great variety of IHC biomarkers have been validated and employed in clinical and research laboratories for characterization of specific cellular events, e.g., the nuclear protein Ki-67 associated with cell proliferation, the cellular tumor antigen P53 associated with tumor formation, and the human epidermal growth factor receptor 2 (HER2) associated with aggressive breast tumor development. Due to its capability of selectively identifying targeted biomarkers, IHC staining of tissue has been established as one of the gold standards for tissue analysis and diagnostic decisions, guiding disease treatment and investigation of pathogenesis.

Though widely used, the IHC staining of tissue still requires a dedicated laboratory infrastructure and skilled operators (histotechnologists) to perform laborious tissue preparation steps and is therefore time-consuming and costly. Recent years have seen rapid advances in deep learning-based virtual staining techniques, providing promising alternatives to the traditional histochemical staining workflow by computationally staining the microscopic images captured from label-free thin tissue sections, bypassing the laborious and costly chemical staining process. Such label-free virtual staining techniques have been demonstrated using autofluorescence imaging, quantitative phase imaging, light scattering imaging, among others, and have successfully created multiple types of histochemical stains, e.g., hematoxylin and eosin (H&E), Masson's trichrome, and Jones silver stains. For example, Rivenson, Y. et al. disclosed a deep learning-based virtual histology structural staining of tissue using auto-fluorescence of label-free tissue. See Rivenson, Y. et al., Deep learning-based virtual histology staining using auto-fluorescence of label-free tissue. Nat Biomed Eng 3, 466-477 (2019).

These previous works, however, did not perform any virtual IHC staining and mainly focused on the generation of structural tissue staining, which enhances the contrast of specific morphological features in tissue sections. In a related line of research, deep learning has also enabled the prediction of biomarker status such as Ki-67 quantification. See Liu, Y. et al., Predict Ki-67 Positive Cells in H&E-Stained Images Using Deep Learning Independently From IHC-Stained Images, Frontiers in Molecular Biosciences 7, (2020). Additional biomarkers investigated include tumor prognostic from H&E-stained microphotographs of various malignancies including hepatocellular carcinoma, breast cancer, bladder cancer, thyroid cancer, and melanoma. These studies highlight a possible correlation between the presence of specific biomarkers and morphological microscopic changes in the tissue; however, they do not provide an alternative to IHC stained tissue images that reveal sub-cellular biomarker information for pathologists' diagnostic inspection for e.g., inter- and intra-cellular signatures such as cytoplasmic and nuclear details.

IHC staining selectively highlights specific proteins or antigens in the cells by antigen-antibody binding process. There are various IHC biomarkers (the specific proteins to be detected), which are the indicators of different cellular events, such as cancer stages, cell proliferation or cell apoptosis. The identification of certain IHC biomarkers (e.g., HER2 protein) can direct the molecular-targeted therapies and predict the prognosis. IHC staining, however, is often more complicated, costly and time-consuming to perform compared to structural staining (hematoxylin and eosin (H&E), Masson's trichrome, Jones silver, etc.). Different IHC staining may be performed depending on tissue types, diseases, and cellular events to be evaluated. Unlike IHC staining, structural stains like H&E operate in a different manner where hematoxylin stains the acidic tissue components (e.g., nucleus) while eosin stains other components (e.g., cytoplasm, extracellular fibers). H&E can be used in almost all organ types to provide a quick overview of the tissue morphological features such as the tissue structure and nuclei distribution. Unlike IHC, H&E cannot identify the specific expressed proteins. For example, the HER2-positive (cells with overexpressed HER2 proteins on their membrane) and HER2-negative (cells without HER2 proteins on their membrane) cells appear the same in the H&E-stained images.

### SUMMARY

Here, a deep learning-based label-free virtual IHC staining method is disclosed (FIGS. 1a-1c), which transforms autofluorescence microscopic images of unlabeled tissue sections into bright-field equivalent images, substantially matching the standard IHC stained images of the same tissue samples. The method was specifically focused on the IHC staining of HER2, which is an important cell surface receptor protein that is involved in regulating cell growth and differentiation. Assessing the level of HER2 expression in breast tissue, i.e., HER2 status, is routinely practiced based on the HER2 IHC staining of the formalin-fixed, paraffin-embedded (FFPE) tissue sections, and helps predict the prognosis of breast cancer and its response to HER2-directed immunotherapies. For example, the intracellular and extracellular studies of HER2 have led to the development of pharmacological anti-HER2 agents that benefit the treatment of HER2-positive tumors. Further efforts are being made to develop new pharmacological solutions that can counter HER2-directed-drug resistance and improve treatment outcomes in clinical trials. With numerous animal models established for preclinical studies and life sciences related research, a deeper understanding of the oncogene, biological functionality, and drug resistance mechanisms of HER2 is being explored. In addition to these, HER2 biomarker was also used as an essential tool in developing and testing of novel biomedical imaging, statistics, and spatial transcriptomics methods.

In one embodiment, a method of generating a digitally stained immunohistochemical (IHC) microscopic image of a label-free tissue that reveals features specific to at least one biomarker or antigen in the tissue sample. The method includes providing a trained, deep neural network that is executed by image processing software using one or more processors of a computing device, wherein the trained, deep neural network is trained with a plurality of matched immunohistochemical (IHC) stained training images or image patches and their corresponding autofluorescence training images or image patches of the same tissue sample; obtaining one or more autofluorescence images of the label-free tissue sample with a fluorescence imaging device; inputting the one or more autofluorescence images of the label-free tissue sample to the trained, deep neural network; and the trained, deep neural network outputting the digitally stained IHC microscopic image of the label-free tissue sample that reveal the features specific to the at least one target biomarker that appears substantially equivalent to a corresponding image of the same label-free tissue sample had it been IHC stained chemically.

In another embodiment, a system for generating a digitally stained immunohistochemical (IHC) microscopic image of a label-free tissue sample that reveals features specific to at least one biomarker or antigen in the tissue sample. The system includes a computing device having image processing software executed thereon or thereby, the image processing software comprising a trained, deep neural network that is executed using one or more processors of the computing device, wherein the trained, deep neural network is trained with a plurality of matched immunohistochemical (IHC) stained training images or image patches and their corresponding autofluorescence training images or image patches of the same tissue sample, the image processing software configured to receive a one or more autofluorescence images of the label-free tissue sample using a fluorescence imaging device and output the digitally stained IHC microscopic image of the label-free tissue sample that reveal the features specific to the at least one target biomarker that appears substantially equivalent to a corresponding image of the same label-free tissue sample had it been IHC stained chemically.

The features specific to the at least one biomarker or antigen in the tissue sample may include specific intracellular features such as staining intensity and/or distribution in the cell membrane, nucleus, or other cellular structures. Features may also include other criteria such as number of nuclei, average nucleus size, membrane region connectedness, and area under the characteristic curve (e.g., membrane staining ratio as a function of saturation threshold).

### BRIEF DESCRIPTION OF THE DRAWINGS

FIG. 1a schematically illustrates a system that is used to generate a digitally/virtually HER2 stained output image of a label-free breast tissue sample according to one embodiment. The HER2 stained output image is a bright-field equivalent microscope image that matches the standard chemically performed HER2 IHC staining of breast tissue that is currently performed.

FIGS. 1b-1c illustrate virtual HER2 staining of unlabeled tissue sections via deep learning. The top portion of FIG. 1b illustrates the standard immunohistochemical (IHC) HER2 staining (top) relies on tedious and costly tissue processing performed by histotechnologists, which typically takes ˜1 day. The bottom portion of FIG. 1b illustrates how a pre-trained deep neural network enables virtual HER2 staining of unlabeled tissue sections. FIG. 1c illustrates the digital or virtual HER2 staining transforming autofluorescence images of unlabeled tissues sections into bright-field equivalent images that substantially match the images of standard IHC HER2 staining.

FIGS. 2a-2b illustrate an embodiment of the digital or virtual HER2 staining neural network. A GAN framework which consists of a generator model and a discriminator model was used to train the virtual HER2 staining network. FIG. 2a shows the generator network which uses an attention-gated U-net structure (with attention gate (AG) blocks) to map the label-free autofluorescence images into bright-field equivalent HER2 images. FIG. 2b show a discriminator network that uses a CNN composed of five successive two-convolutional-layer residual blocks and two fully connected layers. Once the network models converge, only the generator model (FIG. 2a) is used to infer the virtual HER2 images, which takes ˜12 seconds for 1 mm² of tissue area.

FIG. 3 shows a comparison of virtual and standard IHC HER2 staining of breast tissue sections at different HER2 scores. Image panels a, b, c1, c2, d1, d2, e1, e2, f, g, h1, h2, i1, i2, j1, j2, k, 1, m1, m2, n1, n2, o1, o2, p, q, r1, r2, s1, s2, t1, and t2 are shown. Image panels a, f, k, p are bright-field WSIs of standard IHC HER2 stained samples at (image panel a) HER2 3+, (image panel f) HER2 2+, (image panel k) HER2 1+, and (image panel 3p) HER2 0. Image panels b, g, 1, q are bright-field WSIs generated by virtual staining, corresponding to the same samples as a, f, 1, p respectively. Image panels c1-e1, c2-e2 are zoomed-in regions of interest from image panels a, b at a HER2 score of 3+. Image panels h1-j1, h2-j2 are zoomed-in regions of interest from image panels f, g at a HER2 score of 2+. Image panels m1-o1, m2-o2 are zoomed-in regions of interest from image panels k, 1 at a HER2 score of 1+. Image panels r1-t1, h2-t2 are zoomed-in regions of interest from image panels p, q at a HER2 score of 0.

FIGS. 4a-4b illustrate the confusion matrices of HER2 scores. Each element in the matrices represents the number of WSIs with their HER2 scores evaluated by board-certified pathologists (rows) based on: FIG. 4a—virtual HER staining or FIG. 4b—standard IHC HER2 staining, compared to the reference (ground truth) HER2 scores provided by UCLA TPCL (columns).

FIGS. 5a-5e: comparisons of image quality of virtual HER2 and standard IHC HER2 staining. FIG. 5a: quality scores of virtual HER2 and standard IHC HER2 images calculated based on four (4) different feature metrics: nuclear details, absence of staining artifacts, absence of excessive background staining, and membrane clearness. Each value was averaged over all the image patches and pathologists. FIGS. 5b-5e: detailed comparisons of quality scores under each feature metric at different HER2 scores. The grade scale applied for each metric is 1 to 4:4 for perfect, 3 for very good, 2 for acceptable, and 1 for unacceptable. The standard deviations are plotted by dashed lines.

FIGS. 6a and 6b are feature-based quantitative assessment of virtually stained HER2 images and standard IHC HER2 images. FIG. 6a: virtual HER2 features and standard IHC HER2 features, quantitatively compared for HER2 negative cases (N=4,142 images) based on four different metrics. FIG. 6b: virtual HER2 features and standard IHC HER2 features, quantitatively compared for HER2 positive cases (N=4,052 images) based on the same metrics.

FIG. 7 illustrates examples of unsuccessful chemical IHC staining. Image panel a illustrates the pseudo-colored autofluorescence image captured using an unlabeled breast tissue section. Image panel b illustrates the virtual HER2 staining predicted by the generator network. Image panel c illustrates the same tissue section suffered from severe tissue damage and loss during standard IHC HER2 staining. Image panel d illustrates the IHC staining of a serially sliced section from the same sample block. Image panel e illustrates the pseudo-colored autofluorescence image captured using another unlabeled breast tissue section. Image panel f illustrates the virtual HER2 staining predicted by the generator network. Image panel g illustrates the same tissue section experienced false negative IHC HER2 staining (i.e., unsuccessful IHC staining). Image panel h illustrates the IHC staining of a serially sliced section from the same sample block.

FIGS. 8a-8b: HER2 scores corresponding to image patches. FIG. 8a: histograms of HER2 scores graded based on the image patches cropped from virtual HER2 WSI and standard IHC HER2 WSI of each patient. FIG. 8b: individual HER2 scores corresponding to image patches graded by three pathologists.

FIGS. 9a-9b show a comparison of virtual staining network performance with different autofluorescence input channels. FIG. 9a: visual comparisons of virtual staining networks trained with one (DAPI), two (DAPI+FITC), three (DAPI+FITC+TxRed), and four (DAPI+FITC+TxRed+Cy5) autofluorescence input channels, showing the improved results as the number of input channels increases. FIG. 9b: quantitative evaluations of virtual staining networks trained with different numbers of autofluorescence input channels. MSE, SSIM, and SSIM of membrane color channel (i.e., DAB stain) were calculated using the network output and the ground truth images.

FIGS. 10a-10b: Examples of color deconvolution to split the diaminobenzidine (DAB) stain channel and the Hematoxylin stain channel. FIG. 10a: color deconvolution of a HER2 positive region. FIG. 10b: color deconvolution of a HER2 negative region.

FIG. 11 illustrates image preprocessing and registration workflow (showing image panels a-g). Image panel a: stitched autofluorescence WSI (before the IHC staining) and the bright-field WSI (after the IHC staining) of the same tissue section. Image panel b: global registration of autofluorescence WSI and bright-field WSI by detecting and matching the SURF feature points. Image panel c: cropped coarsely matched autofluorescence and bright-field image tiles. Image panel d: registration model was trained to transform the autofluorescence images to the bright-field images. Image panel e: registration model output and ground truth images. Image panel f: the ground truth images were registered to autofluorescence images using an elastic registration algorithm. Image panel g: perfectly matched autofluorescence and bright-field image patches were obtained after 3-5 rounds of iterative registration.

FIG. 12: Quantitative comparison of different virtual staining network architectures. Both the visual and numerical comparisons revealed the superior performance of the attention-gated GAN used in our work compared to other network architectures.

FIG. 13: Comparison of the color distributions of the output images (with strong HER2 expression) generated by different virtual staining networks. The color distributions of the output images generated by the attention-gated GAN closely match the color distributions of the standard IHC ground truth images.

FIG. 14: Comparison of the color distributions of the output images (with weak HER2 expression) generated by different virtual staining networks. The color distributions of the output images generated by the attention-gated GAN closely match the color distributions of the standard IHC ground truth images.

FIG. 15: Extraction of the nucleus and membrane stain features based on color deconvolution and segmentation algorithms.

### DETAILED DESCRIPTION OF ILLUSTRATED EMBODIMENTS

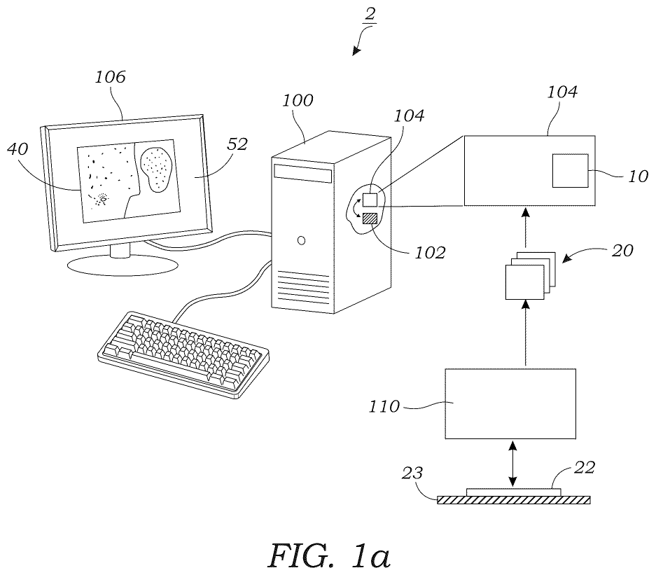

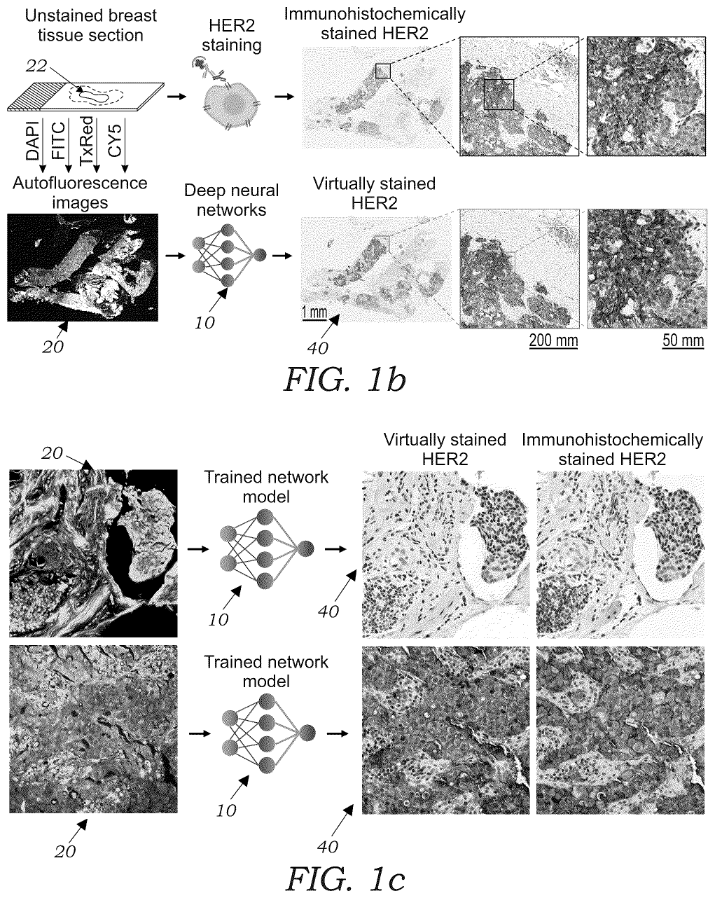

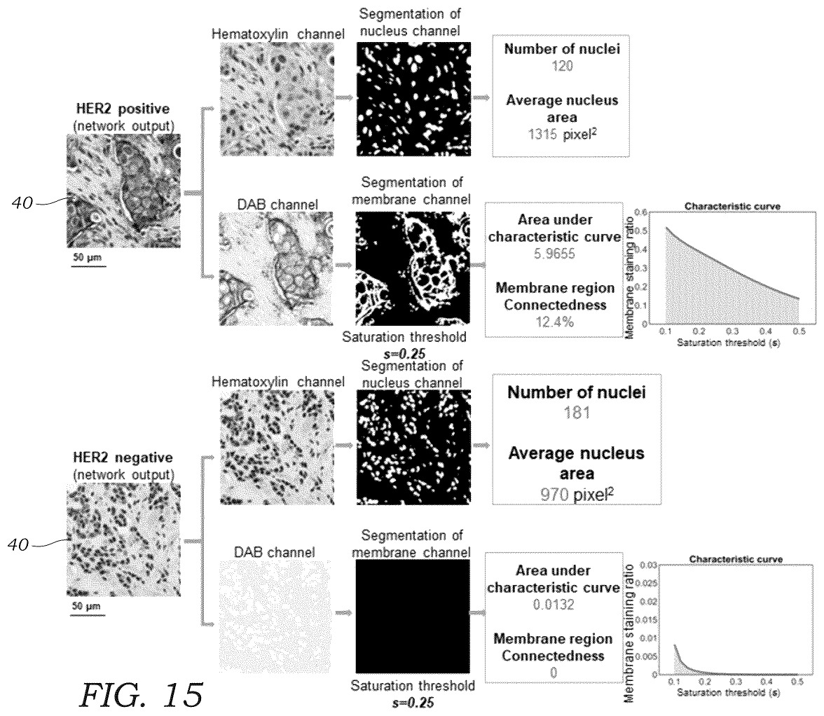

FIGS. 1a, 1b (bottom), and 1c schematically illustrates one embodiment of a system 2 (FIG. 1a) and method (FIG. 1b (bottom) and FIG. 1c) for outputting digitally or virtually stained IHC images 40 of label-free tissue revealing features specific to at least one biomarker or antigen in the tissue sample obtained from one or more input autofluorescence microscope images 20 of a label-free tissue sample 22 (e.g., breast tissue in one specific example). The features specific to at least one biomarker or antigen may include specific intracellular features such as staining intensity and/or distribution in the cell membrane, nucleus, or other cellular structures. Features may also include other criteria such as number of nuclei, average nucleus size, membrane region connectedness, and area under the characteristic curve (membrane staining ratio as a function of saturation threshold—FIG. 15). As explained herein, the one or more input images 20 is/are an autofluorescence image(s) 20 of label-free tissue sample 22. The tissue sample 22 is not stained or labeled with a fluorescent stain or label. Namely, the autofluorescence image(s) 20 of the label-free tissue sample 22 captures fluorescence that is emitted by the label-free tissue sample 22 that is the result of one or more endogenous fluorophores or other endogenous emitters of frequency-shifted light contained therein. Frequency-shifted light is light that is emitted at a different frequency (or wavelength) that differs from the incident frequency (or wavelength). Endogenous fluorophores or endogenous emitters of frequency-shifted light may include molecules, compounds, complexes, molecular species, biomolecules, pigments, tissues, and the like. In some embodiments, the input autofluorescence image(s) 20 is subject to one or more linear or non-linear pre-processing operations selected from contrast enhancement, contrast reversal, image filtering.

The system 2 includes a computing device 100 that contains one or more processors 102 therein and image processing software 104 that incorporates the trained, deep neural network 10 (e.g., a convolutional neural network as explained herein in one or more embodiments). The computing device 100 may include, as explained herein, a personal computer, laptop, mobile computing device, remote server, or the like, although other computing devices may be used (e.g., devices that incorporate one or more graphic processing units (GPUs)) or other application specific integrated circuits (ASICs) as the one or more processors 102). GPUs or ASICs can be used to accelerate training as well as final output images 40. The computing device 100 may be associated with or connected to a monitor or display 106 that is used to display the digitally stained IHC images 40 (e.g., HER2 images). The display 106 may be used to display a Graphical User Interface (GUI) that is used by the user to display and view the digitally stained IHC images 40. In one preferred embodiment, the trained, deep neural network 10 is a Convolution Neural Network (CNN).

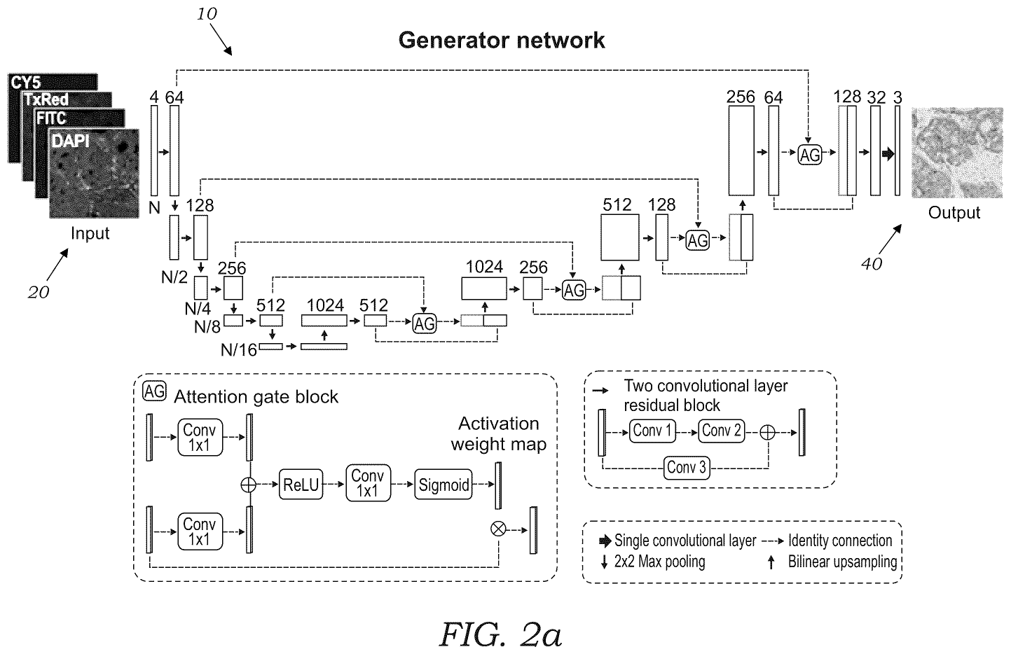

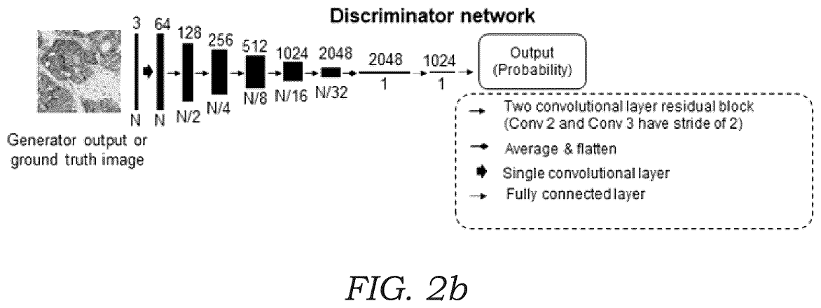

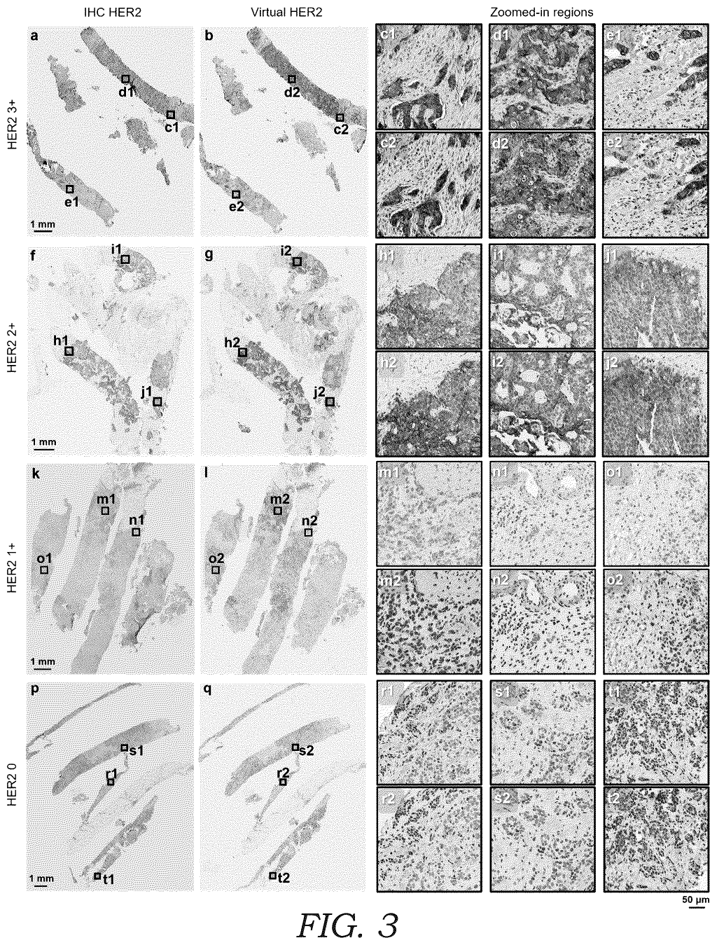

For example, in one preferred embodiment as is described herein, the trained, deep neural network 10 is trained using a GAN model. In a GAN-trained deep neural network 10, two models are used for training. A generative model (e.g., generator network in FIG. 2a) is used that captures data distribution while a second model estimates the probability that a sample came from the training data rather than from the generative model (e.g., discriminator network in FIG. 2b). Details regarding GAN may be found in Goodfellow et al., Generative Adversarial Nets., Advances in Neural Information Processing Systems, 27, pp. 2672-2680 (2014), which is incorporated by reference herein as well as FIG. 2a and the accompanying description herein. Network training of the deep neural network 10 (e.g., GAN) may be performed by the same or different computing device 100. For example, in one embodiment a personal computer may be used to train the GAN-based deep neural network 10 although such training may take a considerable amount of time. To accelerate this training process, one or more dedicated GPUs may be used for training. As explained herein, such training and testing was performed on GPUs obtained from a commercially available graphics card. Once the deep neural network 10 has been trained, the generator network portion of the deep neural network 10, may be used or executed on a different computing device 100 which may include one with less computational resources used for the training process (although GPUs may also be integrated into execution of the trained deep neural network 10).

The image processing software 104 can be implemented using conventional software packages and platforms. This includes, for example, MATLAB, Python, and Pytorch. The trained deep neural network 10 is not limited to a particular software platform or programming language and the trained deep neural network 10 may be executed using any number of commercially available software languages or platforms (or combinations thereof). The image processing software 104 that incorporates or runs in coordination with the trained, deep neural network 10 may be run in a local environment or a remote cloud-type environment. In some embodiments, some functionality of the image processing software 104 may run in one particular language or platform (e.g., image preprocessing and registration) while the trained deep neural network 10 may run in another particular language or platform. Nonetheless, both operations are carried out by image processing software 104.

With reference to FIG. 1a, in one embodiment, the trained, deep neural network 10 receives a single autofluorescence image 20 of a label-free tissue sample 22. In other embodiments, for example, where multiple excitation channels are used, there may be multiple autofluorescence images 20 of the label-free tissue sample 22 that are input to the trained, deep neural network 10 (e.g., one image per channel). These channels may include, for example, DAPI, FITC, TxRed, and Cy5 which are obtained using different filters/filter cubes in the imaging device 110. For example, multiple autofluorescence images 20 obtained with different filters/filter cubes in the imaging device 110 can be input to the trained, deep neural network 10 (e.g., two or more different channels).

The autofluorescence images 20 may include a wide-field autofluorescence image 20 of label-free tissue sample 22. Wide-field is meant to indicate that a wide field-of-view (FOV) is obtained by scanning or otherwise obtaining smaller FOVs, with the wide FOV being in the size range of 10-2,000 mm². For example, smaller FOVs may be obtained by a scanning fluorescence microscope 110 that uses image processing software 104 to digitally stitch the smaller FOVs together to create a wider FOV. Wide FOVs, for example, can be used to obtain whole slide images (WSI) of the label-free tissue sample 22. The autofluorescence image(s) 20 is/are obtained using a fluorescence imaging device 110. For the fluorescent embodiments described herein, this may include a fluorescence microscope 110. The fluorescence microscope 110 includes one or more excitation light source(s) that illuminates the label-free tissue sample 22 as well as one or more image sensor(s) (e.g., CMOS image sensors) for capturing autofluorescence that is emitted by fluorophores or other endogenous emitters of frequency-shifted light contained in the label-free tissue sample 22. The fluorescence microscope 110 may, in some embodiments, include the ability to illuminate the label-free tissue sample 22 with excitation light at multiple different wavelengths or wavelength ranges/bands. This may be accomplished using multiple different light sources and/or different filter sets (e.g., standard UV or near-UV excitation/emission filter sets). In addition, the fluorescence microscope 110 may include, in some embodiments, multiple filters that can filter different emission bands. For example, in some embodiments, multiple fluorescence images 20 may be captured, each captured at a different emission band using a different filter set (e.g., filter cubes). For example, the fluorescence microscope 110 may include different filter cubes for different channels DAPI, FITC, TxRed, and Cy5.

The label-free tissue sample 22 may include, in some embodiments, a portion of tissue that is disposed on or in a substrate 23. The substrate 23 may include an optically transparent substrate in some embodiments (e.g., a glass or plastic slide or the like). The label-free tissue sample 22 may include a tissue section that are cut into thin sections using a microtome device or the like. The label-free tissue sample 22 may be imaged with or without a cover glass/cover slip. The label-free tissue sample 22 may involve frozen sections or paraffin (wax) sections. The label-free tissue sample 22 may be fixed (e.g., using formalin) or unfixed. In some embodiments, the label-free tissue sample 22 is fresh or even live. The methods described herein may also be used to generate digitally stained IHC images 40 of label-free tissue samples 22 in vivo.

As explained herein, in one specific embodiment, the label-free tissue sample 22 is a label-free breast tissue sample and the digitally or virtually stained IHC images 40 that are generated are digitally stained HER2 microscopic images of the label-free breast tissue sample 22. It should be appreciated that other types of tissues beyond breast tissue and other types of biomarker targets other than HER2 may be used in connection with the systems 2 and methods described herein. In IHC staining, a primary antibody is typically employed that targets the antigen or biomarker/biomolecule of interest. A secondary antibody is then typically used that binds to the primary antibody. Enzymes such as horseradish peroxidase (HRP) are attached to the secondary antibody and are used to bind to a chromogen such as DAB or alkaline phosphatase (AP) based-chromogen. A counterstain such as hematoxylin may be applied after the chromogen to provide better contrast for visualizing underlying tissue structure. The methods and systems described herein are used to generate digitally stained IHC images of label-free tissue that reveal features specific to at least one biomarker or antigen in the tissue sample.

### Experimental

The presented virtual HER2 staining method is based on a deep learning-enabled image-to-image transformation, using a conditional generative adversarial network (GAN), as shown in FIGS. 2a-2b. Once the training phase was completed, two blinded quantitative studies were performed using new breast tissue sections with different HER2 scores to demonstrate the efficacy of the virtual HER2 staining framework. For this purpose, the semi-quantitative Dako HercepTest scoring system was used, which involves assessing the percentage of tumor cells that exhibit membranous staining for HER2 along with the intensity of the staining. The results are reported as 0 (negative), 1+(negative), 2+(weakly positive/equivocal), and 3+(positive). In the first study, three board-certified breast pathologists blindly graded the HER2 scores of virtually stained HER2 whole slide images 40 (WSIs) as well as their IHC stained standard counterparts. The results and the statistical analysis revealed that determining the HER2 status based on the virtual HER2 WSIs 40 is as accurate as standard analysis based on the chemically-prepared IHC HER2 slides. In the second study, the same pathologists rated the staining quality of both virtual HER2 and standard IHC HER2 images using different metrics, i.e., nuclear detail, membrane clearness, background staining, and staining artifacts. This study revealed that at least two pathologists out of the three agreed that there is no statistically significant difference between the virtual HER2 staining image quality and the standard IHC HER2 staining image quality in the level of nuclear detail, membrane clearness, and absence of staining artifacts. Additional feature-based quantitative assessments also confirmed the high degree of agreement between the virtually generated HER2 images and their standard IHC-stained counterparts, in terms of both nucleus and membrane stain features.

The presented framework achieved the first demonstration of label-free virtual IHC staining, and bypasses the costly, laborious, and time-consuming IHC staining procedures that involve toxic chemical compounds. This virtual HER2 staining technique has the potential to be extended to virtual staining of other biomarkers and/or antigens and may accelerate the IHC-based tissue analysis workflow in life sciences and biomedical applications, while also enhancing the repeatability and standardization of IHC staining.

### Results

### Label-Free Virtual HER2 Staining of Breast Tissue

The virtual HER2 staining of breast tissue sample 22 was demonstrated by training deep neural network (DNN) models 10 with a dataset of twenty-five (25) breast tissue sections collected from nineteen (19) unique patients, constituting in total 20,910 imagepatches, each with 1024×1024 pixels. Once a DNN model 10 was trained, it virtually stained the unlabeled tissue sections using their autofluorescence microscopic images 20 captured with DAPI, FITC, TxRed, and Cy5 filter cubes (see Methods section), matching the corresponding bright-field images of the same field-of-views, captured after standard IHC HER2 staining. In the network training and evaluation process, a cross-validation approach was employed. Separate network models 10 were trained with different dataset divisions to generate 12 virtual HER2 WSIs for blind testing, i.e., three (3) WSIs at each of the four (4) HER2 scores (0, 1+, 2+, and 3+). Each virtual HER2 WSI corresponds to a unique patient that was not used during the network training phase. Note that all the tissue sections 22 were obtained from existing tissue blocks, where the HER2 reference (ground truth) scores were provided by UCLA Translational Pathology Core Laboratory (TPCL) under UCLA IRB 18-001029.

FIG. 3 summarizes the comparison of the virtual HER2 images 40 inferred by the DNN models 10 against their corresponding IHC HER2 images captured from the same tissue sections after standard IHC staining. Image panels a-t2 are shown in FIG. 3. Both the WSIs and the zoomed-in regions show a high degree of agreement between virtual staining and standard IHC staining. These results indicate that a well-trained virtual staining network 10 can reliably transform the autofluorescence images 20 of unlabeled breast tissue sections 22 into the bright-field equivalent, virtual HER2 images 40, which match their IHC HER2 stained counterparts, across all the HER2 statuses, 0, 1+, 2+, and 3+. Upon close examination, the board-certified pathologists confirmed that the comparison between the IHC and virtual HER2 images 40 showed equivalent staining with no significant perceptible differences in intracellular features such as membrane clarity or nuclear details. In particular, the virtual staining network 10 clearly produced the expected intensity and distribution of membranous HER2 staining (DAB staining or lack thereof) in tumor cells. In HER2 positive (3+, FIG. 3—image panels a-e2) breast cancers, both virtually stained and IHC stained images showed strong complete membranous staining in >10% of tumor cells, as well as dim cytoplasmic staining in tumor cells. None of the stromal and inflammatory cells showed false positive staining and the nuclear details of the tumor cells were comparable in both panels. In equivocal (2+, FIGS. 3f-3j2) tumors, virtual images showed weak to moderate membranous staining in >10% of tumor cells, providing the same amount of membranous staining of tumor cells in corresponding areas. HER2 negative (1+, FIGS. 3k-3o2) tumors showed faint membranous staining in 10% or more of tumor cells. None of the stromal and inflammatory cells showed faint staining. HER2 negative (0, FIGS. 3p-3t2) tumor showed no staining in the tumor cells.

### Blind Evaluation and Quantification of Virtual HER2 Staining

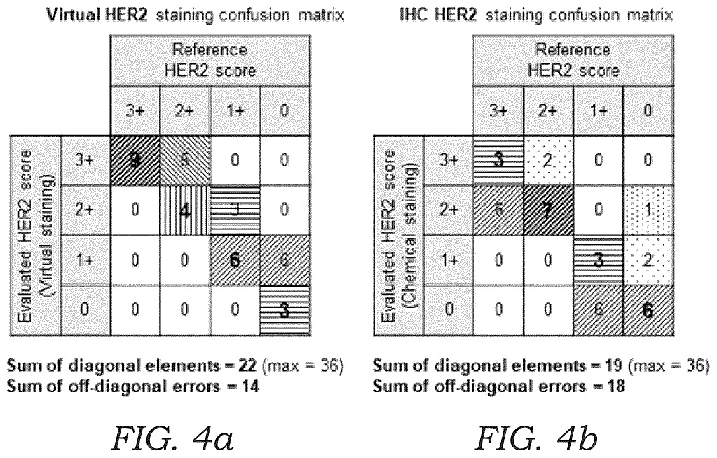

Next, the efficacy of the virtual HER2 staining framework was evaluated with a quantitative blinded study in which the twelve (12) virtual HER2 WSIs 40 and their corresponding standard IHC HER2 WSIs were mixed and presented to three board-certified breast pathologists who graded the HER2 score (i.e., 3+, 2+, 1+, or 0) for each WSI without knowing if the image was from a virtual stain or standard IHC stain. Random image shuffling, rotation, and flipping were applied to the WSIs to promote blindness in evaluations. The HER2 scores of the virtual and the standard IHC WSIs that were blindly graded by the three pathologists are summarized in FIGS. 4a, 4b and compared to their reference, ground truth scores provided by UCLA TPCL. The confusion matrices of virtual HER2 WSIs 40 (FIG. 4a) and IHC HER2 WSIs (FIG. 4b), each corresponding to N=36 evaluations, reveal that the virtual HER2 staining approach achieved a similar level of accuracy for HER2 status assessment as the standard IHC staining. Close examination of these confusion matrices reveals that the sum of the diagonal elements of the virtual HER2-based evaluations (22) is higher than that of the IHC HER2 (19), showing that more cases were correctly scored based on virtual HER2 WSIs 40 compared to those based on standard IHC HER2 WSIs. Furthermore, the sum of the absolute off-diagonal errors of virtual HER2-based evaluations (14) is smaller than that of the standard IHC HER2 (18). Based on the same confusion matrices shown in FIGS. 4a, 4b, a chi-square test was performed to compare the degree of agreement between virtual staining and standard IHC staining methods in HER2 scoring. The test results indicate that there is no statistically significant difference between the two methods (P=0.4752, see Table 1 below).

TABLE 1

| | Virtual HER2 | IHC HER2 | Total |
|---|---|---|---|
| Disagree | 14 | 17 | 31 |
| | 38.89 | 47.22 | |
| Agree | 22 | 19 | 41 |
| | 61.11 | 52.78 | |
| Total | 36 | 36 | 72 |
| Statistic | DF | Value | Prob. |
| Chi-Square | 1 | 0.5098 | 0.4752 |
| Likelihood Ratio Chi-Square | 1 | 0.5105 | 0.4749 |
| Continuity Adj. Chi-Square | 1 | 0.2266 | 0.6341 |
| Mantel-Haenszel Chi-Square | 1 | 0.5028 | 0.4783 |

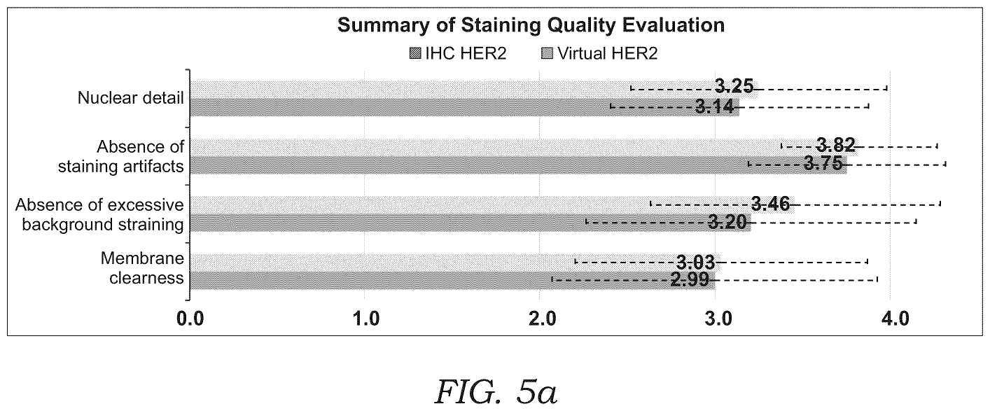

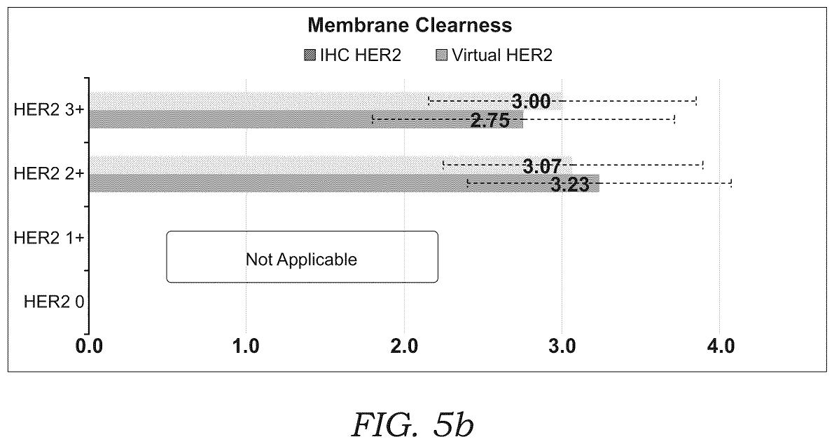

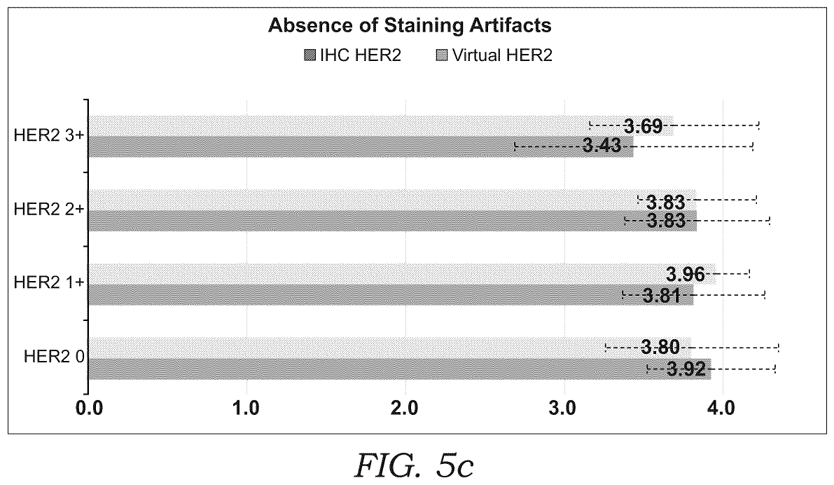

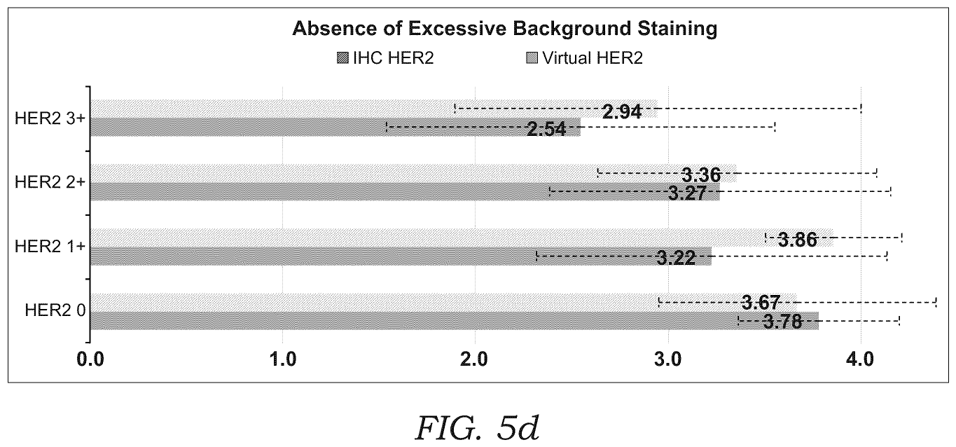

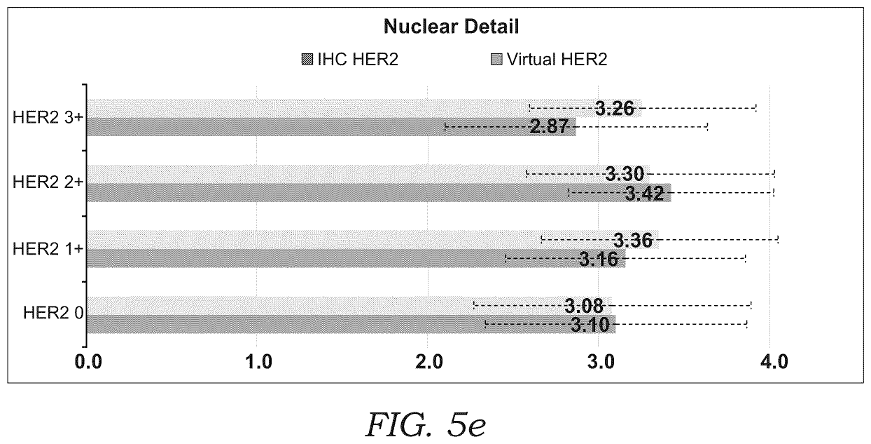

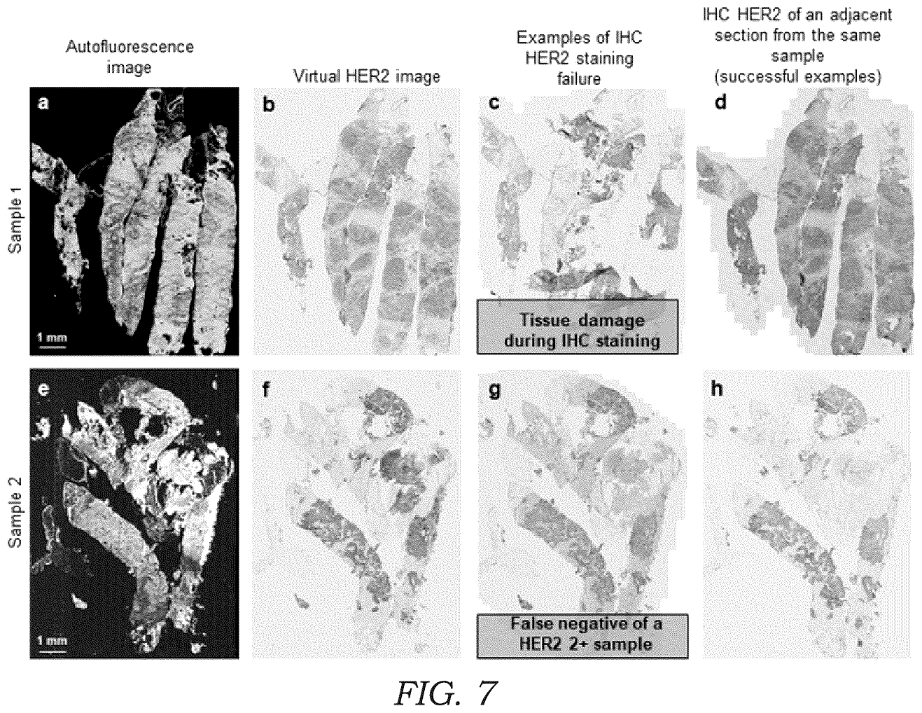

In addition to evaluating the efficacy of virtual staining in HER2 scoring, the staining quality of the virtual HER2 images 40 was quantitatively evaluated and were compared to the standard IHC HER2 images. In this blinded study, ten (10) regions-of-interest (ROIs) were randomly extracted from each of the twelve (12) virtual HER2 WSIs and ten (10) ROIs at the same locations from each of their corresponding IHC HER2 WSIs, building a test set of 240 image patches. Each image patch has 8000×8000 pixels (1.3×1.3 mm²), which was also randomly shuffled, rotated, and flipped before being reviewed by the same three pathologists. These pathologists were asked to grade the image quality of each ROI based on four pre-designated feature metrics for HER2 staining: membrane clearness, nuclear detail, absence of excessive background staining, and absence of staining artifacts (FIGS. 5a-5e). The grade scale for each metric is from 1 to 4, with 4 representing perfect, 3 representing very good, 2 representing acceptable, and 1 representing unacceptable. FIG. 5a summarizes the staining quality scores of virtual HER2 and standard IHC HER2 images based on the pre-defined feature metrics, which were averaged over all image patches and pathologists. FIGS. 5b-5e further compare the average quality scores at each of the 4 HER2 statuses under each feature metric. In FIG. 5b, the membrane clearness scores of HER2 negative ROIs are noted as “not applicable” since there is no staining of the cell membrane in HER2 negative samples. It is important to emphasize that, the standard IHC HER2 images had an advantage in these comparisons because they were pre-selected: a significant percentage of the standard IHC HER2 tissue slides suffered from unacceptable staining quality issues (see Discussion and FIG. 7 image panels a-h), and therefore they were excluded from the comparative studies in the first place. Nevertheless, the quality scores of virtual and standard IHC HER2 staining are very close to each other and fall within their standard deviations (dashed lines in FIG. 5). One-sided t-tests were also performed on each feature metric evaluated by board-certified pathologists to determine whether standard IHC HER2 images are statistically significantly better than the virtual HER2 images 40 in staining quality. The t-test results showed that only for the metric of ‘absence of excessive background staining,’ two of the three pathologists reported a statistically significant improvement in the quality of the standard IHC staining compared to the virtual staining. For the rest of the feature metrics (i.e., nuclear details, membrane clearness, and staining artifacts), at least two of the three pathologists reported that the staining quality of the IHC HER2 images is not statistically significantly better than their virtual HER2 counterparts (Table 2 below). Also note that the virtually stained HER2 images 40 did not mislead the diagnosis at the whole slide level as also analyzed using the confusion matrices shown in FIGS. 4a and 4b and the chi-square test reported in Table 1.

TABLE 2

| | Pathologist #1 | | Pathologist #2 | | Pathologist #3 | |
|---|---|---|---|---|---|---|
| | Mean | Pr < t | Mean | Pr < t | Mean | Pr < t |
| Membrane | 0.1000 | 0.8615 | −0.1207 | 0.1986 | −0.1000 | 0.2324 |
| clearness | | | | | | |
| Absence of | −0.0250 | 0.3536 | −0.1833 | 0.0113 | 0.0000 | 0.5000 |
| staining | | | | | | |
| artifacts | | | | | | |
| Absence of | −0.2500 | 0.0017 | −0.0583 | 0.1692 | −0.4500 | <.0001 |
| excessive | | | | | | |
| background | | | | | | |
| staining | | | | | | |
| Nuclear | −0.2000 | 0.0007 | −0.0250 | 0.3018 | −0.1083 | 0.0772 |
| details | | | | | | |

Difference=quality score of virtually stained image−quality score of IHC stained image

Null hypothesis: Difference_{Virtual-IHC}≥0

Alternative hypothesis: Difference_{Virtual-IHC}<0

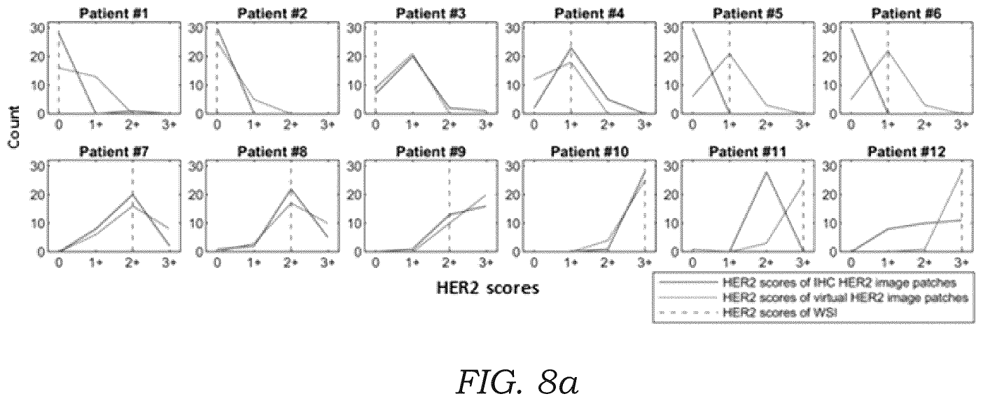

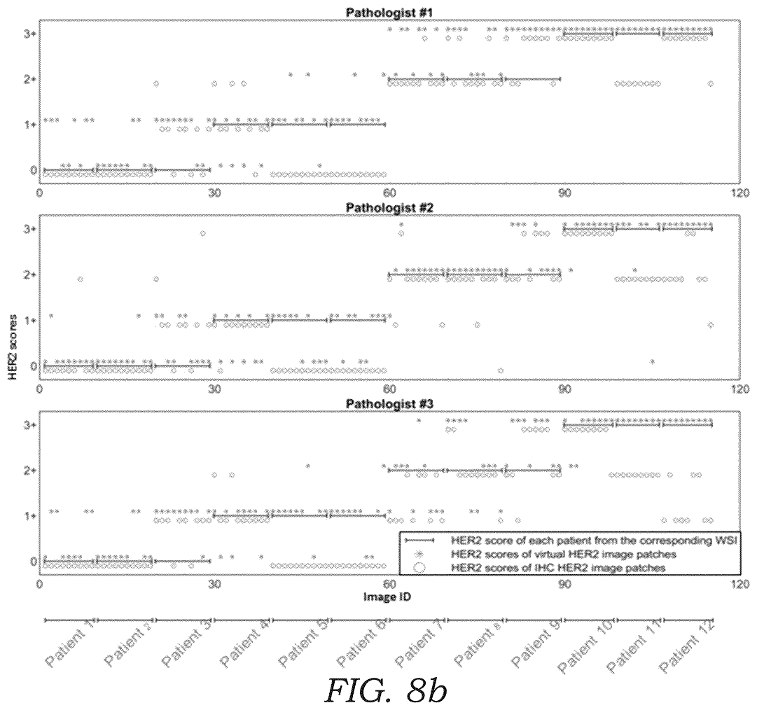

Besides rating the staining quality of each ROI, the pathologists also graded a HER2 score for each ROI, the results of which are reported in FIGS. 8a-8b. Each histogram in FIG. 8a summarizes the HER2 scores of the ten (10) ROIs extracted from each WSI evaluated by three pathologists (i.e., N=30 evaluations). The reference (ground truth) HER2 scores of the corresponding WSIs are plotted as gray vertical dashed lines. This analysis reveals that, for the majority of the patients, there is no discrepancy between HER2 scores evaluated from virtually generated ROIs and standard IHC stained ROIs. For the cases where there is a disagreement (e.g., Patients #5 and #11), the histograms of the virtual HER2 scores were centered closer to the reference HER2 scores (dashed lines) compared to the histograms of the standard IHC-based HER2 scores. It is important to also note that grading the HER2 scores from sub-sampled ROIs vs. from the WSI can yield different results due to the inhomogeneous nature of the tissue sections.

### Feature-Based Quantitative Assessment of Virtual HER2 Staining

In addition to the pathologists' blind assessments of the virtual staining efficacy and the image quality, a feature-based quantitative analysis was conducted of the virtually generated HER2 images compared to their IHC-stained counterparts. In this analysis, 8194 unique test image patches (each with a size of 1024×1024 pixels) were blindly selected for virtual staining. Due to the different staining features of each different HER2 status, these blind testing images were divided into two subsets for quantitative evaluation: one subset containing the images from HER2 0 and HER2 1+, N=4142, and the other containing the images from HER2 2+ and HER2 3+, N=4052. For each virtually stained HER2 image 40 and its corresponding IHC HER2 image (ground truth), four feature-based quantitative evaluation metrics (specifically designed for HER2) were calculated based on the segmentation of nucleus stain and membrane stain (see the Methods section). These four feature-based evaluation metrics included the number of nuclei and the average nucleus area (in number of pixels) for quantifying the nucleus stain in each image as well as the area under the characteristic curve and the membrane region connectedness for quantifying the membrane stain in each image (refer to the Methods section for details).

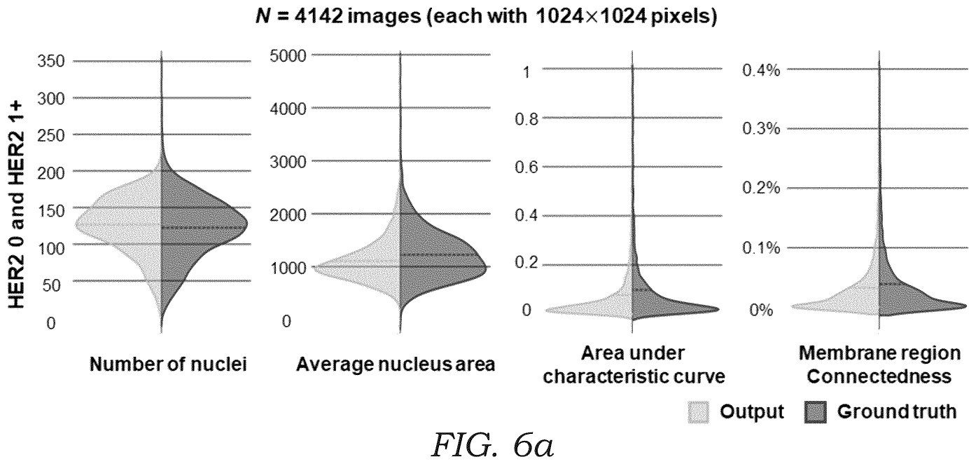

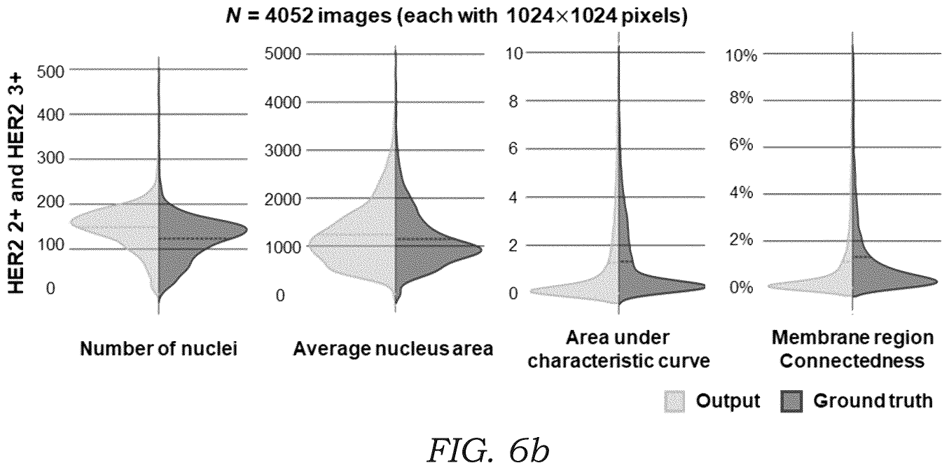

These feature-based quantitative evaluation results for the virtual HER2 images 40 compared against their standard IHC counterparts are shown in FIGS. 6a-6b. This analysis demonstrated that the virtual HER2 staining feature metrics exhibit similar distributions and closely matching average values (horizontal dashed lines) compared to their standard IHC counterparts, in terms of both the nucleus and the membrane stains. By comparing the evaluation results of the HER2 positive group (2+ and 3+) against the HER2 negative group (0 and 1+), similar distributions of nucleus features are observed (i.e., the number of nuclei and average nucleus area) and higher levels of membrane stain, which correlates well with the higher HER2 scores as expected.

### DISCUSSION

A deep learning-enabled label-free virtual IHC staining method and system 2 is disclosed herein. By training a DNN model 10, the method generated virtual HER2 images 40 from the autofluorescence images 20 of unlabeled tissue sections 22, matching the bright-field images captured after standard IHC-staining. Compared to chemically performing the IHC staining, the virtual HER2 staining method is rapid and simple to operate. The conventional IHC HER2 staining involves laborious sample treatment steps demanding a histotechnologist's periodic monitoring, and this whole process typically takes one day before the slides can be reviewed by diagnosticians. In contrast, the presented virtual HER2 staining method bypasses these laborious and costly steps, and generates the bright-field equivalent HER2 images 40 computationally using the autofluorescence images 20 captured from label-free tissue sections 22. After the training is complete (which is a one-time effort), the entire inference process using a virtual staining network only takes ˜12 seconds for 1 mm² of tissue using a consumer-grade computer 100, which can be further improved by using faster hardware acceleration processors 102/units.

Another advantage of the presented method is its capability of generating highly consistent and repeatable staining results, minimizing the staining variations that are commonly observed in standard IHC staining. The IHC HER2 staining procedure is delicate and laborious as it requires accurate control of time, temperature, and concentrations of the reagents at each tissue treatment step; in fact, it often fails to generate satisfactory stains. In the study, ˜30% of the sample slides were discarded because of unsuccessful standard IHC staining and/or severe tissue damage even though the IHC staining was performed by accredited pathology labs. FIG. 7 (image panels c, g) shows two examples of the standard IHC staining failures that were experienced, including complete tissue damage and false negative staining that failed to reflect the correct HER2 score. In contrast, computational virtual staining approach does not rely on the chemical processing of the tissue and generates reproducible results, which is important for the standardization of the HER2 interpretation by eliminating commonly experienced staining variations and artifacts.

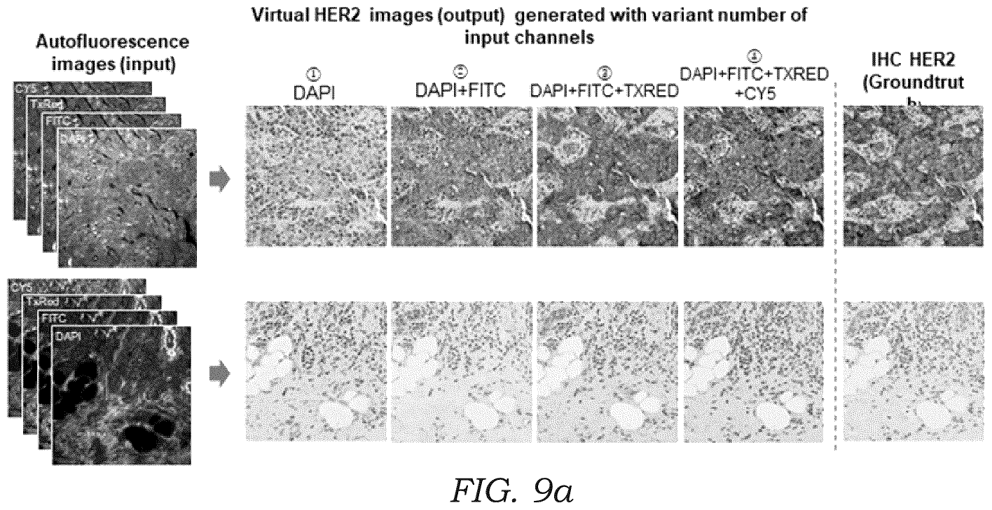

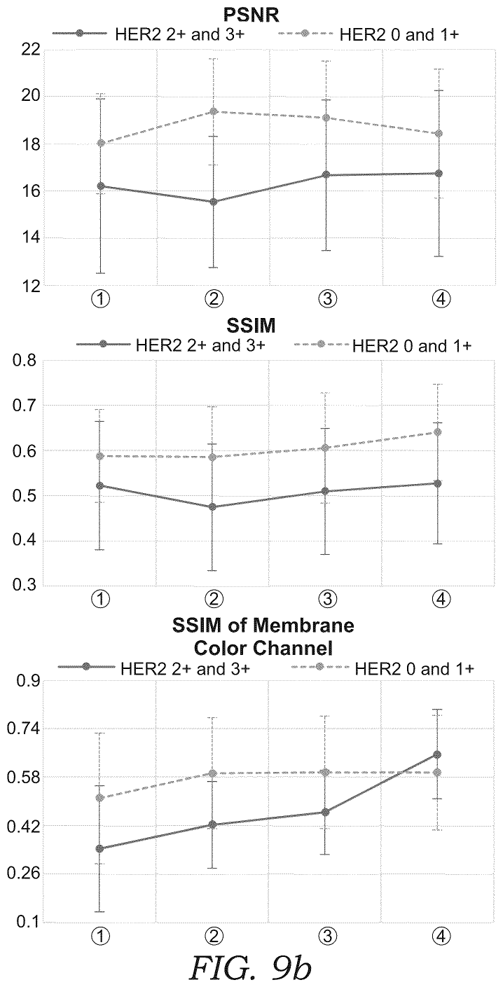

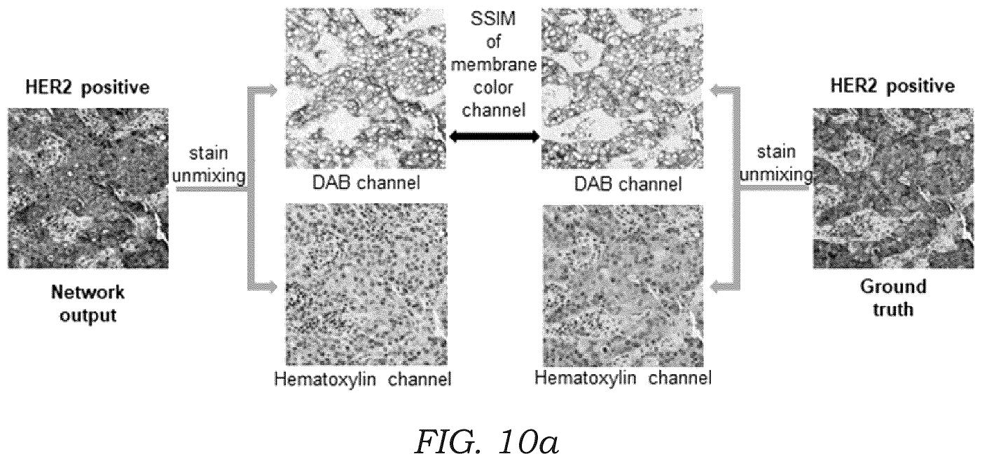

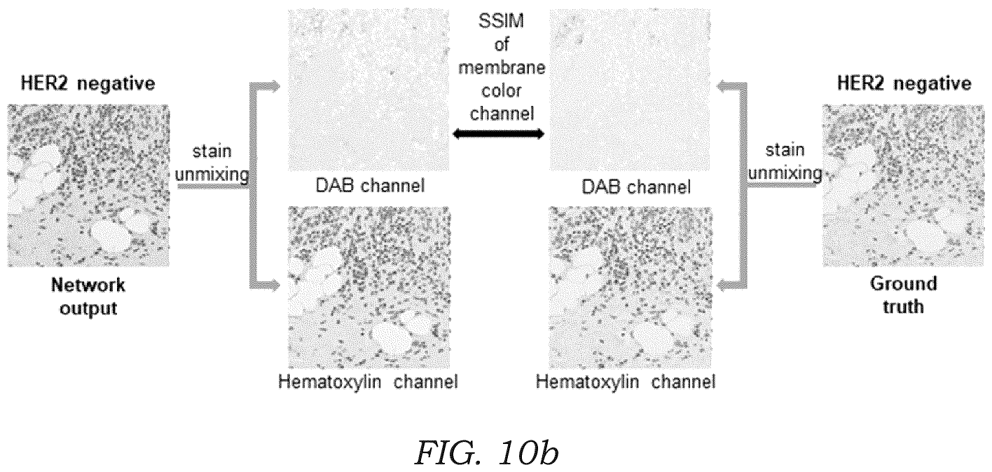

Since the autofluorescence input images 20 of tissue slices 22 were captured with standard filter sets installed on a conventional fluorescence microscope 110, the presented approach is ready to be implemented on existing fluorescence microscopes 110 without hardware modifications or customized optical components. The results showed that the combination of the four commonly used fluorescence filters (DAPI, FITC, TxRed, and Cy5) provided a very good baseline for the virtual HER2 staining performance. See FIG. 9a. As an ablation study, virtual staining networks 10 that are trained with different autofluorescence input channels by calculating peak signal-to-noise ratio (PSNR) and structural similarity index (SSIM) were quantitatively compared between the network output and ground truth images (see FIG. 9b). Since the staining of the cell membrane is an important assessment factor in HER2 status evaluation, color deconvolution was also performed to split out the membrane stain channel (i.e., diaminobenzidine, DAB stain) (FIGS. 10a-10b) followed by calculating and comparing the SSIM scores (FIGS. 9a-9b). These analyses revealed that the performance of the virtual staining network 10 partially degraded with decreasing number of input autofluorescence channels, motivating the use of DAPI, FITC, TxRed, and Cy5 altogether (FIG. 9b).

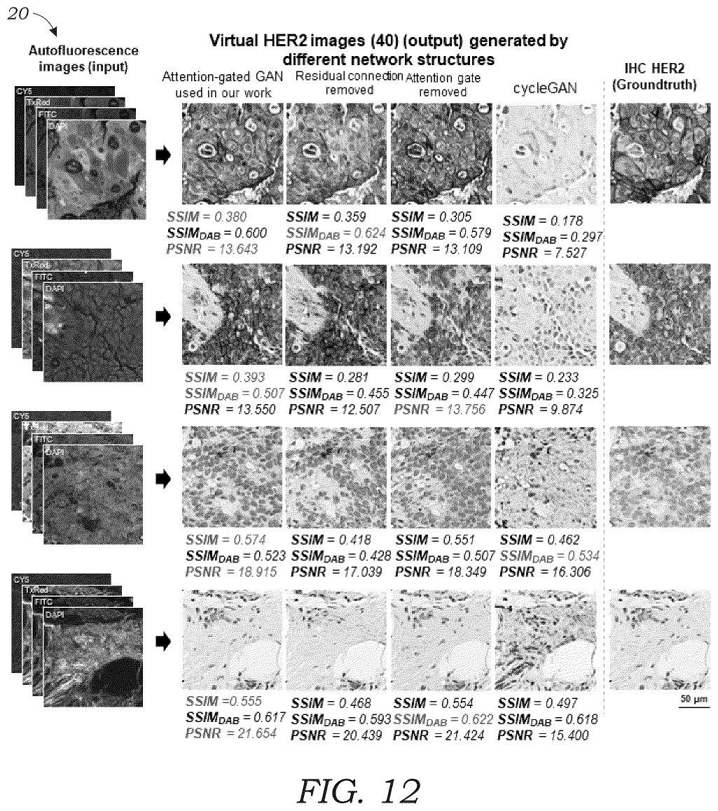

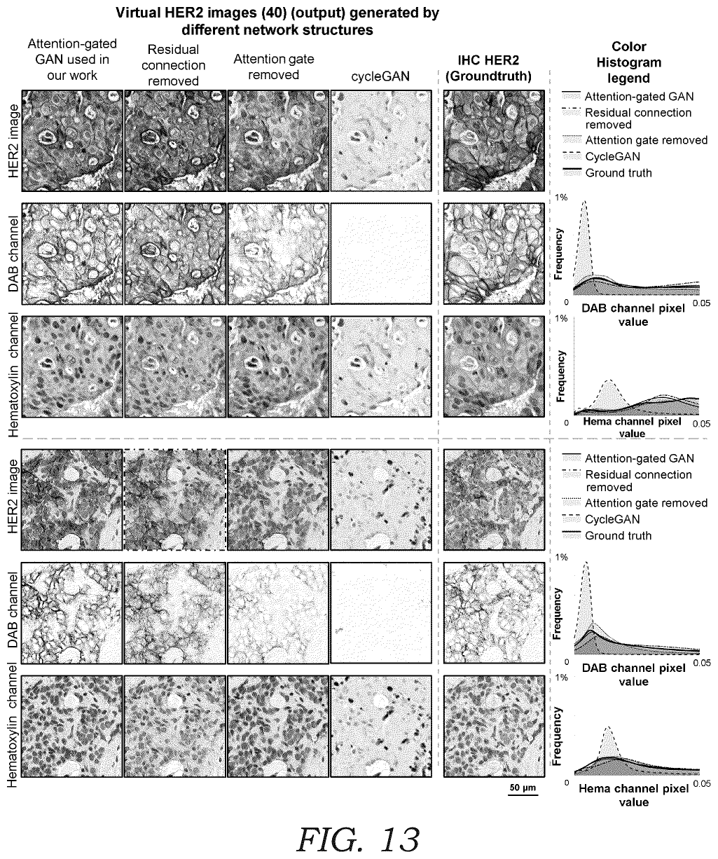

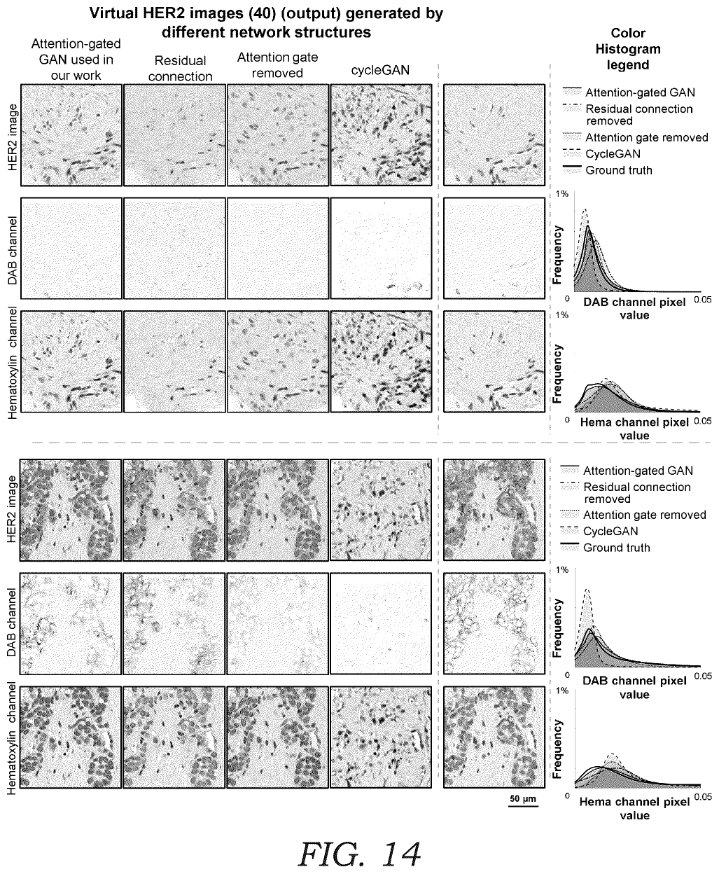

The advantages of using the attention-gated GAN structure for virtual HER2 staining are illustrated by an additional comparative study, in which four different network architectures 10 were trained and blindly tested including: 1) the attention-gated GAN structure used herein, 2) the same structure with the residual connections removed, 3) the same structure with the attention-gated blocks removed, and 4) an unsupervised cycleGAN framework. The training/validation/testing datasets and the training epochs were kept the same for all the four networks 10. After their training, a quantitatively comparison of these networks 10 was done by calculating the PSNR, SSIM, and SSIM of the membrane stain (SSIM_{DAB}) between the network output and the ground truth images (see FIG. 12). Both the visual and numerical comparisons revealed that the attention-gated GAN used herein is the only network architecture that could provide consistently superior and accurate virtual staining results at various HER2 expression levels, while the other network architectures made some catastrophic staining errors in one or more testing FOVs, making them unacceptable for consistent inference across all HER2 statuses. In FIGS. 13-14, the color distributions were further compared (see the Methods section) of the output images 40 generated by these different network architectures against the corresponding ground truth images, including FOVs with strong HER2 expression (FIG. 13) and FOVs with weak HER2 expression (FIG. 14). These additional comparisons showed that the color histograms of the output images generated by the framework match with the standard IHC ground truth much more closely for both the membrane and nucleus stain channels, which again illustrates the advantages of using the attention-gated GAN architecture for the trained, deep neural network 10 reported herein.

The success of the virtual HER2 staining method relies on the processing of the complex spatial-spectral information that is encoded in the autofluorescence images 20 of label-free tissue 22 using convolutional neural networks 10. The presented virtual staining method can potentially be expanded to a wide range of other IHC stains. Though the virtual HER2 staining framework was demonstrated based on autofluorescence imaging of unlabeled tissue sections 22, other label-free microscopy modalities may also be utilized for this task, such as holography, fluorescence lifetime imaging and Raman microscopy. In addition to generalizing to other types of IHC stains in the assessment of various biomarkers, this method can be further adapted to non-fixed fresh tissue samples or frozen sections, which can potentially provide real-time virtual IHC images for intraoperative consultation during surgical operations.

### Methods

### Sample Preparation and Standard IHC Staining

The unlabeled breast tissue blocks were provided by the UCLA TPCL under UCLA IRB 18-001029 and were cut into 4 μm thin sections 22. The FFPE thin sections 22 were then deparaffinized and covered with glass coverslips. After acquiring the autofluorescence microscopic images 20, the unlabeled tissue sections 22 were sent to accredited pathology labs for standard IHC HER2 staining, which was performed by UCLA TPCL and the Department of Anatomic Pathology of Cedars-Sinai Medical Center in Los Angeles, USA. The IHC HER2 staining protocol provided by UCLA TPCL is described in IHC HER2 staining protocol (Methods).

### Image Data Acquisition

The autofluorescence images 20 of the unlabeled tissue sections were captured using a standard fluorescence microscope 110 (IX-83, Olympus) with a ×40/0.95 NA (UPLSAPO, Olympus) objective lens. Four fluorescent filter cubes, including DAPI (Semrock DAPI-5060C-OFX, EX 377/50 nm, EM 447/60 nm), FITC (Semrock FITC-2024B-OFX, EX 485/20 nm, EM 522/24 nm), TxRed (Semrock TXRED-4040C-OFX, EX 562/40 nm, EM 624/40 nm), and Cy5 (Semrock CY5-4040C-OFX, EX 628/40 nm, EM 692/40 nm) were used to capture the autofluorescence images 20 at different excitation-emission wavelengths. Each autofluorescence image 20 was captured with a scientific complementary metal-oxide-semiconductor (sCMOS) image sensor (ORCA-flash4.0 V2, Hamamatsu Photonics) with an exposure time of 150 ms, 500 ms, 500 ms, and 1000 ms for DAPI, FITC, TxRed, and Cy5 filters, respectively. Images were normalized for the four (4) channels by their respective exposure times. Thus, DAPI images (for training and test) were divided by their exposure time of 150 ms. The other channels were normalized to their respective exposure times. The image acquisition process was controlled by pManager (version 1.4) microscope automation software. After the standard IHC HER2 staining is complete, the bright-field WSIs were acquired using a slide scanner microscope (AxioScan Z1, Zeiss) with a ×20/0.8 NA objective lens (Plan-Apo).

### Image Preprocessing and Registration

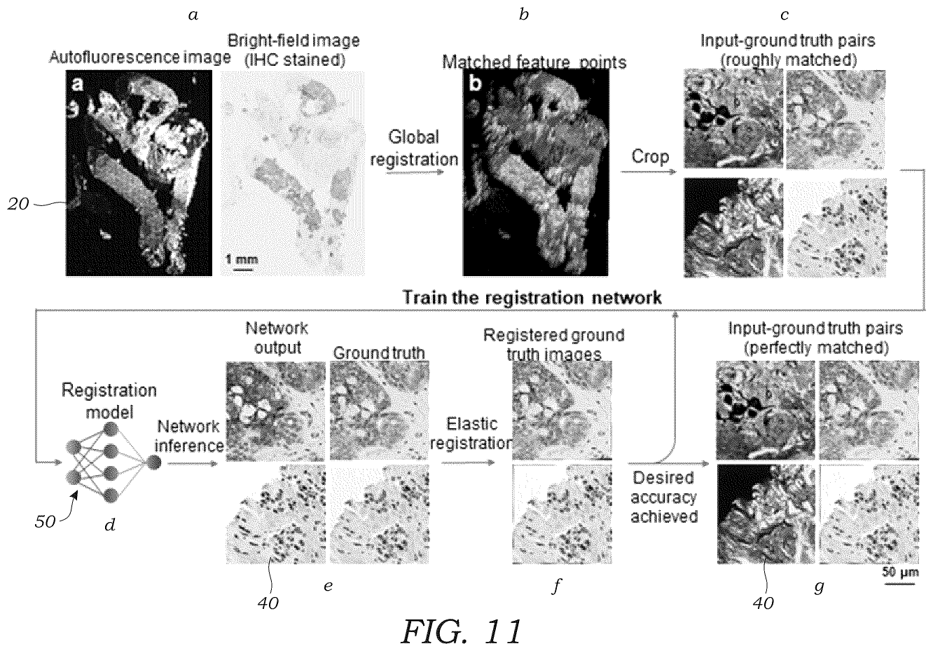

The matching of the autofluorescence images 20 (network input) and the bright-field IHC HER2 (network ground truth) image pairs is critical for the successful training of an image-to-image transformation network. The image processing workflow for preparing the training dataset for the virtual HER2 staining network is described in FIG. 11 and image panels a-g, which was implemented in MATLAB (MathWorks). First, the autofluorescence images 20 (before the IHC staining) and the whole-slide bright-field images (after the IHC staining) of the same tissue sections were stitched into WSIs (image panel a) and globally co-registered by detecting and matching the speeded up robust features (SURF) points (image panel b). Then, these coarsely matched autofluorescence and bright-field WSIs were cropped into pairs of image tiles of 1024×1024 pixels (image panel c). These image pairs were not accurately matched at the pixel level due to optical aberrations and morphological changes of the tissue structure during the standard (laborious) IHC staining procedures. In order to calculate the transformation between the autofluorescence image 20 and its bright-field counterpart using a correlation-based elastic registration algorithm, a registration model needs to be trained to match the style of the autofluorescence images to the style of the bright-field images (image panel d). This registration network 50 used the same architecture as the virtual staining network 10. Following the image style transformation using the registration network 50 (image panel e), the pyramid elastic image registration algorithm was performed to hierarchically match the local features of the sub-image blocks and calculate the transformation maps. The transformation maps were then applied to correct for the local wrappings of the ground truth images (image panel f) which were then better matched to their autofluorescence counterparts. This training-registration process (image panels d-f) was repeated 3-5 times until the autofluorescence input and the bright-field ground truth image patches were accurately matched at the single pixel-level (image panel g). At last, a manual data cleaning process was performed to remove image pairs with artifacts such as tissue-tearing (during the standard chemical staining process) or defocusing (during the imaging process).

### Virtual HER2 Staining Network Architecture and Training Schedule

A GAN-based network model 10 was employed to perform the transformation from the 4-channel label-free autofluorescence images (DAPI, FITC, TxRed, and Cy5) to the corresponding bright-field virtual HER2 images, as shown in FIGS. 2a, 2b. This GAN framework includes (1) a generator network that creates virtually stained HER2 images 40 by learning the statistical transformation between the input autofluorescence images 20 and the corresponding bright-field IHC stained HER2 images (ground truth), and (2) a discriminator network that learns to discriminate the virtual HER2 images 40 created by the generator from the actual IHC stained HER2 images. The generator and the discriminator were alternatively optimized and simultaneously improved through this competitive training process. Specifically, the generator (G) and discriminator (D) networks were optimized to minimize the following loss functions:

$${l}_{generator} = α \times {L}_{1} \{ {I}_{target} , G ( {I}_{input} ) \} - λ \times log ( ( 1 + SSIM \{ {I}_{target} , G ( {I}_{input} ) \} ) / 2 ) + γ \times BCE \{ D ( G ( {I}_{input} ) ) , 1 \}$$

$${l}_{discriminator} = BCE \{ D ( G ( {I}_{input} ) ) , 0 \} + BCE \{ D ( {I}_{target} ) , 1 \}$$

where G(·) represents the generator inference, D(·) represents the probability of being a real, actually-stained IHC image predicted by the discriminator, Iᵢₙₚᵤₜ denotes the input label-free autofluorescence images, and I_{target} denotes the ground truth, standard IHC stained image. The coefficients (α, λ, γ) in I_{generator} were empirically set as (10, 0.2, 0.5) to balance the pixel-wise smooth L₁ error of the generator output with respect to its ground truth, SSIM loss of the generator output, and the binary cross-entropy (BCE) loss of the discriminator predictions of the output image. Compared to using the mean squared error (MSE) loss, the smooth L₁ loss is a robust estimator that prevents exploding gradients by using MSE around zero and mean absolute error (MAE) in other parts. Specifically, smooth L₁ loss between two images A and B is defined as:

$${L}_{1} \{ A , B \} = \frac{1}{M \times N} ( {\sum }_{\begin{matrix}m , n \\ \vert A ( m , n ) - B ( m , n ) \vert < β\end{matrix}} 0.5 \times \frac{{( A ( m , n ) - B ( m , n ) )}^{2}}{β} + {\sum }_{\begin{matrix}m , n \\ \vert A ( m , n ) - B ( m , n ) \vert \geq β\end{matrix}} \vert A ( m , n ) - B ( m , n ) \vert - 0.5 β )$$

where m and n are the pixel indices, the M×N represents the total number of pixels in each image. β was set to 1 in this case.

The SSIM of two images is defined as:

$$SSIM \{ A , B \} = \frac{( 2 {μ}_{A} {μ}_{B} + {c}_{1} ) ( 2 {σ}_{AB} + {c}_{2} )}{( 2 {μ}_{A}^{2} {μ}_{B}^{2} + {c}_{1} ) ( {σ}_{A}^{2} {σ}_{B}^{2} + {c}_{2} )}$$

where μ_{A} and μ_{B} are the mean values of the images A and B, σ_{A}² and σ_{B}² are the variance of images A and B, and σ_{AB} is the covariance between images A and B. c₁ and c₂ were set to be 0.01² and 0.03², respectively.

The BCE with logits loss used in the network is defined as:

$$BCE \{ p , q \} = - [ q \times log ( sigmoid ( p ) ) + ( 1 - q ) \times log ( 1 - sigmoid ( p ) ) ]$$

where p represents the discriminator predictions and q represents the actual labels (0 or 1).

As shown in FIG. 2a, the generator network 10 was built following the attention U-Net architecture with four (4) resolution levels, which can map the label-free autofluorescence images 20 into the digital or virtually HER2 stained images 40 by learning the transformations of spatial features at different spatial scales, catching both the high-resolution local features at shallower levels and the larger scale global context at deeper levels. The attention U-Net structure is composed of a down-sampling path and an up-sampling path that are symmetric to each other. The down-sampling path contains four down-sampling convolutional blocks, each consisting of a two-convolutional-layer residual block, followed by a leaky rectified linear unit (Leaky ReLU) with a slope of 0.1, and a 2×2 max-pooling operation with a stride size of two for down-sampling. The two-convolutional-layer residual blocks contain two consecutive convolutional layers with a kernel size of 3×3 and a convolutional residual path connecting the in and out tensors of the two convolutional layers. The numbers of the input channels and the output channels at each level of the down-sampling path were set to 4, 64, 128, 256, and 64, 128, 256, 512, respectively.

Symmetrically, the up-sampling path contains four up-sampling convolutional blocks with the same design as the down-sampling convolutional blocks, except that the 2× down-sampling operation was replaced by a 2× bilinear up-sampling operation. The input of each up-sampling block is the concatenation of the output tensor from the previous block with the corresponding feature maps at the matched level of the down-sampling path passing through the attention gated connection. An attention gate consists of three convolutional layers and a sigmoid operation, which outputs an activation weight map highlighting the salient spatial features. Notably, attention gates were added to each level of the U-net skip connections. The attention-gated structure implicitly learns to suppress irrelevant regions in an input image while highlighting specific features useful for a specific task.

The numbers of the input channels and the output channels at each level of the up-sampling path were 1024, 1024, 512, 256, and 1024, 512, 256, 128, respectively. Following the up-sampling path, a two-convolutional layer residual block together with another single convolutional layer reduces the number of channels to three, matching that of the ground truth images (i.e., 3-channel RGB images). Additionally, a two-convolutional-layer center block was utilized to connect and match the dimensions of the down-sampling path and the up-sampling path.

The structure of the discriminator network is illustrated in FIG. 2b. An initial block containing one convolutional layer followed by a Leaky ReLU operation first transformed the 3-channel generator output or ground truth image to a 64-channel tensor. Then, five successive two-convolutional-layer residual blocks were added to perform 2× down-sampling and expand the channel numbers of each input tensor. The 2× down-sampling was enabled by setting the stride size of the second convolutional layer in each block as 2. After passing through the five blocks, the output tensor was averaged and flattened to a one-dimensional vector, which was then fed into two fully connected layers to obtain the probability of the input image being the standard IHC-stained image.

The full image dataset contains 25 WSIs from 19 unique patients, making a set of 20,910 image patches, each with a size of 1024×1024 pixels. For the training of each virtual staining model used in the cross-validation studies, the dataset was divided as follows: (1) Test set: images from the WSIs of 1-2 unique patients (˜10%, not overlapped with training or validation patients); after splitting out the test set, the remaining WSIs were further divided to (2) Validation set: images from 2 of the WSIs (˜10%), and (3) Training set: images from the remaining WSIs (˜80%). The network models were optimized using image patches of 256×256 pixels, which were randomly cropped from the images of 1024×1024 pixels in the training dataset. An Adam optimizer with weight decay was used to update the learnable parameters at a learning rate of 1×10⁻⁴ for the generator network and 1×10⁻⁵ for the discriminator network, with a batch size of 28. The generator/discriminator update frequency was set to 2:1. Finally, the best model was selected based on the best MSE loss, assisted with the visual assessment of the validation images. The networks converged after ˜120 hours of training.

### Implementation Details

The image preprocessing was implemented in image processing software 104 (i.e., MATLAB using version R2018b (MathWorks)). The virtual staining network 10 was implemented using Python version 3.9.0 and Pytorch version 1.9.0. The training was performed on a desktop computer 100 with an Intel Xeon W-2265 central processing unit (CPU) 102, 64 GB random-access memory (RAM), and an Nvidia GeForce GTX 3090 graphics processing unit (GPU) 102.

### Pathologist's Blind Evaluation of HER2 Images

For the evaluation of WSIs, 24 high-resolution WSIs were randomly shuffled, rotated, and flipped, and uploaded to an online image viewing platform that was shared with three board-certified pathologists to blindly evaluate and score the HER2 status of each WSI using the Dako HercepTest scoring system. For the evaluation of sub-ROI images, the 240 image patches were randomly shuffled, rotated, and flipped, and uploaded to an online image sharing platform GIGAmacro (https://www.gigamacro.com/). These 240 image patches used for staining quality evaluation can be accessed at:
https://viewer.gigamacro.com/collections/u08mwIpUDAwfR1vQ?sb=date&sd=asc.

The pathologists' blinded assessments are provided in Supplementary Data 1.

### Statistical Analysis

A chi-square test (two-sided) was performed to compare the agreement of the HER2 scores evaluated based on the virtual staining and the standard IHC staining. Paired t-tests (one-sided) were used to compare the image quality of virtual staining vs. standard IHC staining. First, the differences between the scores of the virtual and IHC image patches cropped from the same positions were calculated, i.e., subtracted the score of each IHC stained image from the score of the corresponding virtually stained image. Then one-sided t-tests were performed to compare the differences with 0, by each feature metric and each pathologist. For all tests, a P value of ≤0.05 was considered statistically significant. All the analyses were performed using SAS v9.4 (The SAS Institute, Cary, NC).

### Numerical Evaluation of HER2 Images

For the feature-based quantitative assessment of HER2 images (reported in FIGS. 6a-6b), a color deconvolution (FIGS. 10a-10b) was performed to separate the nucleus stain channel (i.e., hematoxylin stain) and the membrane stain channel (i.e., diaminobenzidine stain, DAB), as shown in FIG. 15. The nucleus segmentation map was obtained using the Otsu's thresholding method followed by morphological operations (e.g., image erosion, image dilation, etc.) on the hematoxylin channel. Based on the binary nucleus segmentation map, the number of nuclei and the average nucleus area were extracted by counting the number of connected regions and measuring the average region area. For the evaluation of the membrane stain, the separated DAB image channel was first transformed into the HSV color space. Then, the segmentation map of the membrane stain was obtained by applying a threshold (s) to the saturation channel. By gradually increasing the threshold value (s) from 0.1 to 0.5 with a step size of 0.02, the ratio of the total segmented membrane stain area to the entire image FOV (i.e., 1024×1024 pixels) was calculated, creating the characteristic curve (FIG. 15). The area under the characteristic curve can be accordingly extracted, providing a robust metric for evaluating HER2 expression levels. By setting the threshold value (s) to 0.25, the ratio of the largest connected component in the membrane segmentation map to the entire image FOV was also extracted as the membrane region connectedness.

For the characterization of the color distribution reported in FIGS. 13-14, the nucleus stain channel and the membrane stain channel were split using the same color deconvolution method as in FIG. 15. For each stain channel, the histogram of all the normalized pixel values was created and followed by a nonparametric kernel-smoothing to fit the distribution profile. Y-axes (i.e., the frequency) of the color histograms shown in FIGS. 13-14 were normalized by the total pixel counts.

### Data Availability

Data supporting the results demonstrated by this study are available herein. The full set of images used for the HER2 status and stain quality assessment studies can be found in the Supplementary Data 1 file and at:
https://viewer.gigamacro.com/collections/u08mwIpUDAwfR1vQ?sb=date&sd=asc which is incorporated herein by reference.

The full pathologist reports can be found in the Supplementary Data 1 file. The full statistical analysis report can be found in Supplementary Data 2 file. Raw WSIs corresponding to patient specimens were obtained under UCLA IRB 18-001029 from the UCLA Health private database for the current study and therefore cannot be made publicly available.

### Code Availability

All the deep-learning models used in this work employ standard libraries and scripts that are publicly available in Pytorch. The codes used in this manuscript can be accessed through GitHub: https://github.com/baibijie/HER2-virtual-staining, which is incorporated by reference herein.

### IHC HER2 Staining Protocol

Paraffin-embedded sections were cut at 4 μm thickness and paraffin was removed with xylene and rehydrated through graded ethanol. Endogenous peroxidase activity was blocked with 3% hydrogen peroxide in methanol for 10 min. Heat-induced antigen retrieval (HIER) was carried out for all sections in AR9 buffer (AR9001KT Akoya) using a decloaking chamber (Biocare Medical) at 95° C. for 25 min. The slides were then stained with HER2 antibody (cell signaling, 4290, 1-200) at 4° C. overnight. The signal was detected using the DakoCytomation Envision System Labelled Polymer HRP anti-rabbit (Agilent K4003, ready to use). All sections were visualized with the diaminobenzidine reaction and counterstained with hematoxylin.

The following publication (including all supplementary materials, supplementary data, and code referenced therein), Bai et al., Label-Free Virtual HER2 Immunohistochemical Staining of Breast Tissue using Deep Learning, BME Frontiers, vol. 2022, Article ID 9786242, 15 pages, 2022 is incorporated by reference herein.

While embodiments of the present invention have been shown and described, various modifications may be made without departing from the scope of the present invention. For example, while the HER2 biomarker was specifically investigated with the label-free virtual immunohistochemical staining of breast tissue, it should be appreciated that the system 2 and methods are applicable to other biomarkers and/or antigens. This includes other types of tissue 22 beyond breast tissue. In addition, the label-free images were demonstrated based on autofluorescence imaging of unlabeled tissue sections but it should be appreciated that other label-free microscopy modalities may be used such as, holography, fluorescence lifetime imaging, and Raman microscopy. The invention, therefore, should not be limited, except to the following claims, and their equivalents.

1. A method of generating a digitally stained immunohistochemical (IHC) microscopic image of a label-free tissue sample, revealing features specific to at least one target biomarker or antigen in the tissue sample comprising:
providing a trained, deep neural network that is executed by image processing software using one or more processors of a computing device, wherein the trained, deep neural network is trained with a plurality of matched immunohistochemical (IHC) stained training images or image patches and their corresponding autofluorescence training images or image patches of the same tissue sample;
obtaining one or more autofluorescence images of the label-free tissue sample with a fluorescence imaging device;
inputting the one or more autofluorescence images of the label-free tissue sample to the trained, deep neural network; and
the trained, deep neural network outputting the digitally stained IHC microscopic image of the label-free tissue sample that reveal the features specific to the at least one target biomarker that further appears substantially equivalent to a corresponding image of the same label-free tissue sample had it been IHC stained chemically.

2. The method of claim 1, wherein the trained, deep neural network comprises a convolutional neural network.

3. The method of claim 1, wherein the deep neural network is trained using a Generative Adversarial Network (GAN) model.

4. The method of claim 1, wherein the tissue comprises breast tissue.

5. The method of claim 1, wherein the at least one target biomarker or antigen in the tissue is human epidermal growth factor receptor 2 (HER2).

6. The method of claim 2, wherein the deep neural network is trained using a generator network configured to learn statistical transformation between the matched IHC stained and autofluorescence images or image patches of the same tissue sample and a discriminator network configured to discriminate between a ground truth IHC stained image of the tissue sample and the outputted digitally stained IHC microscopic image of the tissue sample.

7. The method of claim 2, wherein the trained, deep neural network comprises an attention-gated neural network.

8. The method of claim 1, wherein the one or more autofluorescence images comprise a plurality of autofluorescence images captured at different excitation-emission wavelengths.

9. The method of claim 8, wherein the plurality of autofluorescence images of the label-free tissue sample captured at different excitation-emission wavelengths comprises autofluorescence images obtained in two or more of the following filter channels: DAPI, FITC, TxRed, and Cy5.

10. The method of claim 1, wherein the label-free tissue sample comprises a non-fixed or fresh tissue sample.

11. The method of claim 1, wherein the label-free tissue sample comprises a fixed or frozen tissue sample.

12. The method of claim 1, wherein the label-free tissue sample comprises tissue imaged in vivo.

13. The method of claim 1, wherein the plurality of matched IHC stained and autofluorescence images or image patches of the same tissue sample are subject to a registration process prior to training of the deep neural network, comprising passing the plurality of matched IHC stained and autofluorescence images or image patches through a registration neural network model that matches local styles/features found in the matched IHC stained and autofluorescence images.

14. The method of claim 13, wherein registration further comprising registering the IHC stained images or image patches to respective autofluorescence images or image patches using an elastic registration process.

15. The method of claim 1, wherein the digitally stained IHC microscopic image of the label-free tissue sample is output in real time or near real time after obtaining the one or more autofluorescence images of the label-free tissue sample.

16. The method of claim 1, wherein the fluorescence imaging device comprises a fluorescence microscope.

17. A system for generating a digitally stained immunohistochemical (IHC) microscopic image of a label-free tissue sample, revealing features specific to at least one biomarker or antigen in the tissue sample comprising:
a computing device having image processing software executed thereon or thereby, the image processing software comprising a trained, deep neural network that is executed using one or more processors of the computing device, wherein the trained, deep neural network is trained with a plurality of matched immunohistochemical (IHC) stained training images or image patches and their corresponding autofluorescence training images or image patches of the same tissue sample, the image processing software configured to receive a one or more autofluorescence images of the label-free tissue sample using a fluorescence imaging device and output the digitally stained IHC microscopic image of the label-free tissue sample that reveal the features specific to the at least one target biomarker that further appears substantially equivalent to a corresponding image of the same label-free tissue sample had it been IHC stained chemically.

18. The system of claim 17, wherein the trained, deep neural network comprises a convolutional neural network.

19. The system of claim 18, wherein the trained, deep neural network is trained using a Generative Adversarial Network (GAN) model.

20. The system of claim 17, wherein the tissue comprises breast tissue.

21. The system of claim 17, wherein the at least one target biomarker or antigen in the tissue is human epidermal growth factor receptor 2 (HER2).

22. The system of claim 17, wherein the fluorescence imaging device comprises a fluorescence microscope configured to obtain the one or more autofluorescence images of the label-free tissue sample.

23. The system of claim 22, further comprising a plurality of filters that are used to obtain a plurality of autofluorescence images of the label-free tissue sample captured at different excitation-emission wavelengths.

24. The system of claim 18, wherein the trained, deep neural network comprises an attention-gated neural network.
